(19) United States
(12) Patent Application Publication
(10) Pub. No.: US 2007/0262535 A1
(43) Pub. Date: Nov. 15, 2007

(54) Gasket

(75) Inventor: Toshihiro Imai, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: ISHIKAWA GASKET CO., LTD

(21) Appl. No.: 11/798,081

(22) Filed: May 10, 2007

(30) Foreign Application Priority Data
May 12, 2006 (JP) 2006-134260

(51) Int. Cl. F02F 11/00

(52) U.S. Cl. 277/592

(57) ABSTRACT

A metal gasket for sealing two members with at least one through hole to be sealed includes at least one metal plate constituting the gasket and having a seal-required portion, and at least one hole formed in the metal plate. The at least one hole corresponds to the through hole of the two members. Conductive portions for assuring electrical conductivity between the two members are provided on respective surfaces of the metal plate pressed on the two members. A seal is coated on the seal-required portion for the respective surfaces of the metal plate except for the conductive portion.

### BACKGROUND OF THE INVENTION AND RELATED ART STATEMENT

The present invention relates to a gasket which is formed by one or more metal plates laminating together, and which seals the joint surface between two members, each of which includes at least one through hole to be sealed. The gasket assures electrical conductivity between the two members.

For example, a cylinder head gasket sealing between a cylinder head and a cylinder block for an internal-combustion engine, is generally known as a gasket formed by laminating one or more metal plates, which seals the joint surface between the two members, each of which includes at least one through hole to be sealed.

In this kind of gasket, electrical conductivity for an earth of the two members (cylinder head and cylinder block) or an electrical signal transfer between the two members is sometimes required. However, generally, since a metal plate on which a seal material is preliminarily coated is used, stable electrical conductivity is not assured.

In view of the problems described above, a technical problem of the present invention is to provide a gasket which is placed between the two members, each of which includes at least one through hole to be sealed and can assure stable electrical conductivity between the two members.

Further objects and advantages of the invention will be apparent from the following description of the invention.

### SUMMARY OF THE INVENTION

In order to solve the problem described above, according to the present invention, a gasket is formed by one or more metal plates laminated together, and seals the joint surface between two members, each of which includes at least one through hole to be sealed. Through holes corresponding to the through holes of the two members are provided on the metal plate constituting the gasket, and conductive portions which assure electrical conductivity between the two members are provided on respective surfaces of the metal plate, which are welded with pressure on the two members. Seal-required portions for the respective surfaces of the metal plate except for the conductivity portions, which are pressed on the two members, are coated with a seal material for assuring a seal quality.

According to a preferred embodiment of the gasket of the invention, the two members are a cylinder head and a cylinder block for an internal-combustion engine, and the gasket is a cylinder head gasket placed therebetween. Also, the conductive portions should be made by a bead, a surrounding folded portion, or a current-carrying projection.

In addition, the seal material can be coated after processing of the metal plate.

According to the present invention, the conductive portions assuring electrical conductivity between the two members are provided on the respective surfaces of the metal plate constituting the gasket, which are pressed on the two members. Accordingly, the gasket can reliably respond to the case wherein a stable electrical conductivity is required between the two members.

Also, the seal material is coated on the seal-required portion of the respective surfaces of the metal plate except for at least the conductivity portions, which are pressured on the two members. As a result, a seal quality between the two members can be reliably assured.

### BRIEF DESCRIPTION OF THE DRAWINGS

FIG. 1 is a plan view showing the first embodiment of the present invention;

FIG. 2 is a sectional view taken along line 2-2 in FIG. 1; and

FIG. 3 is a cross sectional view showing the second embodiment of the present invention at the same position as in FIG. 2.

### DETAILED DESCRIPTION OF PREFERRED EMBODIMENTS

Hereunder, embodiments of a gasket according to the present invention which are applied to a cylinder head gasket placed between a cylinder head and a cylinder block for an internal-combustion engine will be described in detail with reference to the attached drawings.

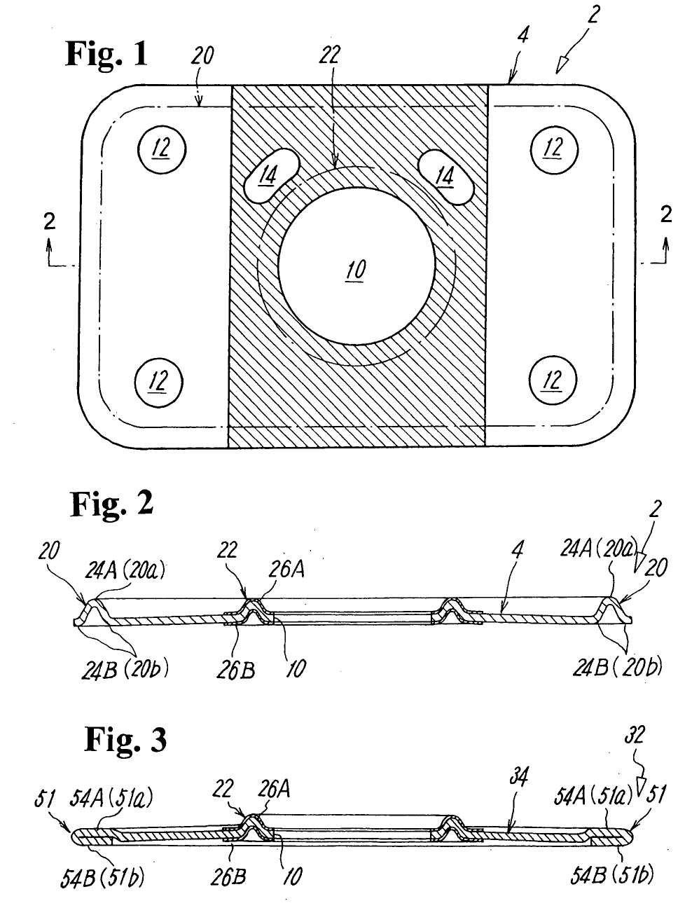

FIGS. 1-2 show the first embodiment of the gasket of the invention.

The cylinder head gasket 2 is composed of a single metal plate 4, and as shown in FIG. 1, the gasket 2 is provided with a combustion chamber hole 10 corresponding to a combustion chamber of the cylinder block (not shown in the figure); and a required number of bolt holes 12 for tightening by tightening bolts and a required number of fluid holes 14, such as water holes and oil holes, which are dispersed around the combustion chamber hole 10.

A periphery bead 20 formed by a full bead is provided on the surface of the metal plate 4, which is pressed on the cylinder head (not shown in the figure), and a seal bead 22 formed by a full bead is provided around the combustion chamber hole 10.

Conductivity portions 24A, 24B for assuring electrical conductivity between the cylinder head and the cylinder block are provided on the respective surfaces of the metal plate 4, which are pressed on the cylinder head and the cylinder block. More specifically, on the surface of the metal plate 4 which is pressed on the cylinder head, the top portion 20a of the periphery bead 20 which is more projected than other flat portions becomes the conductivity portion 24A. On the other hand, on the surface which is pressed on the cylinder block, a larger load acts on the bottom portion 20b of the periphery bead 20, as compared to other areas, by a load distribution when the gasket 2 is placed between the cylinder head and the cylinder block and tightened by the tightening bolt. As a result, the bottom portion 20b can be the conductivity portion 24B.

Seal materials 26A, 26B for assuring a seal quality are coated at the seal-required portions of the respective surfaces of the metal plate 4, except for at least the conductivity portions 24A, 24B which are pressed on the cylinder head and the cylinder block, i.e. a part of the periphery bead 20, around the combustion chamber hole 10 including the seal bead 22 and around the fluid holes 14.

Incidentally, the seal materials 26A, 26B are coated on the metal plate 4 constituting the gasket 2 after the combustion chamber hole 10, the bolt holes 12, the fluid holes 14, the periphery bead 20, and the seal bead 22 are processed. The reason is that if a metal plate whose seal materials are preliminarily coated is used, a special process is required for assuring stable electrical conductivity.

In the gasket 2 with the above-mentioned structure, the conductivity portions 24A, 24B for assuring the electrical conductivity between the cylinder head and the cylinder block are provided on the respective surfaces of the metal plate 4 constituting the gasket 2, which are pressed on the cylinder head and the cylinder block. Accordingly, when the stable electrical conductivity between the cylinder head and the cylinder block is required, the gasket 2 can reliably provide stable electrical conductivity.

Also, the seal materials 26A, 26B are coated on the seal-required portions of the respective surfaces of the metal plate 4, except for at least the conductivity portions 24A, 24B, which are pressed on the cylinder head and the cylinder block. Accordingly, a seal quality between the cylinder head and the cylinder block can be reliably assured.

In addition, the seal materials 26A, 26B are coated on the metal plate 4 constituting the gasket 2 after the combustion chamber hole 10, the bolt holes 12, the fluid holes 14, the periphery bead 20, and the seal bead 22 are processed. Accordingly, the stable electrical conductivity between the cylinder head and the cylinder block can be reliably assured.

Next, FIG. 3 shows the second embodiment of the gasket of the invention, and as in the case of the first embodiment, FIG. 3 shows the case, wherein the second embodiment is applied to a cylinder head gasket 32 placed between the cylinder head and the cylinder block for the internal-combustion engine.

The main structure of the cylinder head gasket 32 of the second embodiment is the same as that of the first embodiment. However, as shown in FIG. 3, a folded portion 51 is provided on the periphery of a metal plate 34. In this case, in the conductivity portions for assuring the electrical conductivity between the cylinder head and the cylinder block, the upper surface 51a of the folded portion 51 which is more projected than the other flat portion becomes a conductivity portion 54A in the surface of the metal plate 34, which is pressed on the cylinder head. On the other hand, even in the surfaces which is pressed on the cylinder block, the lower surface 51b of the folded portion 51 which is more projected than the other flat portion becomes a conductivity portion 54B.

Here, other structures and operations of the second embodiment are substantively the same as those of the first embodiment, so that the same symbols are used for the same portions or corresponding portions, and the explanations are omitted.

Incidentally, in each embodiment, the case wherein the present invention is applied to the gasket formed by a single metal plate is explained; however, the present invention is not limited to the above-mentioned case, and can also be applied to a metal-laminated gasket formed by laminating plural metal plates.

In this case, as in the cases of the first embodiment and the second embodiment, the top portion and the bottom portion of the bead, or the folded portion around the metal plate can be a conductivity portion. However, for example, a positioning projection for preventing misalignment between the laminated metal plates and determining the position of the metal plates can be constituted as a current-carrying projection, or a projection for carrying current can be separately provided and this portion can be a current-carrying portion between the two members.

The disclosure of Japanese Patent Application No. 2006-134260, filed on May 12, 2006, is incorporated in the application. While the invention has been explained with reference to the specific embodiments of the invention, the explanation is illustrative and the invention is limited only by the appended claims.

What is claimed is:

1. A metal gasket for sealing two members with at least one through hole to be sealed, comprising:
at least one metal plate constituting the gasket and having a seal-required portion,
at least one hole formed in the metal plate, said at least one hole corresponding to the through hole of the two members,
conductive portions for assuring electrical conductivity between the two members, said conductive portions being provided on respective surfaces of the metal plate pressed on the two members, and
a seal coated on the seal-required portion for the respective surfaces of the metal plate except for the conductive portion.

2. A metal gasket according to claim 1, wherein said conductive portions are selected from a conductive bead, a folded portion, and a current-carrying projection, formed on the at least one metal plate.

3. A gasket according to claim 2, further comprising a sealing member formed around the at least one hole for sealing therearound.

4. A gasket according to claim 3, wherein said sealing member is a seal bead formed on the at least one metal plate.

5. A gasket according to claim 4, wherein said seal-required portion is formed around the at least one hole, and the seal is formed only on the seal-required portion.

6. A gasket according to claim 5, wherein said conductive portions are formed outside the seal relative to the at least one hole.

7. A gasket according to claim 6, wherein said conductive portions are the conductive bead or the folded portion formed around an edge of the at least one metal plate.
